(19) United States
(12) Patent Application Publication
(10) Pub. No.: US 2011/0231315 A1
(43) Pub. Date: Sep. 22, 2011

(54) METHOD AND SYSTEM FOR MAKING SECURE PAYMENTS

(75) Inventors: Gautam Bandyopadhyay, Bangalore (IN); Kiran Subbakrishna Ramesh Kannambadi, Bangalore (IN)

(73) Assignee: INFOSYS TECHNOLOGIES LIMITED, Bangalore (IN)

(21) Appl. No.: 12/813,668

(22) Filed: Jun. 11, 2010

(30) Foreign Application Priority Data
Mar. 16, 2010 (IN) 700/CHE/2010

(51) Int. Cl. G06Q 40/00

(52) U.S. Cl. 705/44

(57) ABSTRACT

The invention discloses a method, system and computer program product for making secure payments. A customer selects one or more items to be purchased. The customer then enters an authentication detail and a dynamic password, also referred to as a One Time Password (OTP), on an Electronic Data Capture device for authenticating the payment. Based on the authenticity of the OTP and the authentication details, a payment request is sent to an organization for completing the payment.

### BACKGROUND OF THE INVENTION

The present invention relates to the field of electronic transactions. More specifically, it relates to a method and system for making secure payments.

Awareness about the Internet and its applicability in the day-to-day lives of people is growing exponentially. It has become an essential medium for information and communication. Further, the Internet has now become a pivotal medium for various Electronic commerce (E-commerce) services. E-commerce services include, but are not limited to, online shopping, online reservations or booking, online status inquiry, and the like.

For example, during online shopping, a customer may select one or more items from the list of items displayed on an E-commerce website and make a payment. Various methods are available for making such online payments. For an online payment, the customer may make the payment using a debit card or a credit card issued by a financial institution such as a bank. The customer needs to enter credit or debit card details on the E-commerce website. However, providing the credit or debit card details on the E-commerce website may not be safe. There may be a possibility of the credit card and debit card details being hacked over the Internet. Some institutions offer the use of a dynamic credit card number′ for making secure online payments. However, generating a new credit card number for each transaction can be a cumbersome procedure.

Similarly, when the customer purchases an item at a merchant location, he may be required to reveal his account information while making the payment. This may further enhance the possibility of any person misusing the account information of the customers.

In light of the discussion above, there is a need for a secure method for making secure payments. Further, the system should avoid sharing the credit or debit card details with such E-commerce websites or with merchant locations.

### BRIEF SUMMARY OF THE INVENTION

The present invention provides a method, system and computer program product for making secure online payments. In an embodiment of the invention, a customer is registered with an institution such as a bank and a secure payment service provider. Further, the secure payment service provider has collaboration with an Electronic commerce (E-commerce) website for enabling customers to make secure payments on the E-commerce website.

The customer selects one or more items to be purchased on the E-commerce website. The customer then obtains a first One Time Password (OTP) using a mobile device. In an embodiment of the invention, the first OTP may be generated by using an application on the mobile device of the customer. In an embodiment of the invention, the first OTP may be generated by a server of the secure payment service provider. The first OTP generated by the server is then communicated to the mobile device of the customer. The first OTP is generated based on a predefined logic. Thereafter, the customer enters the first OTP and a customer identifier on a secure web page. The secure web page may be linked with the E-commerce website or a website of the secure payment service provider.

A second OTP is generated by the server based on the predefined logic. The authenticity of the first OTP and the customer identifier is checked by the server against the second OTP and a verification data. Based on the authenticity of the first OTP and the customer identifier, the server sends a payment request to an organization, such as a bank, for completing the payment.

In another embodiment of the invention, a customer may make a secure payment at a merchant location. While making the payment at the merchant location, the customer generates the first OTP using his mobile device. The customer may then display the first OTP to an employee of the merchant location. The employee may then enter the first OTP on an Electronic Data Capture (EDC) device, such as a Point-of-Sale device. The EDC device is linked with the server of the secure payment service provider and thus communicates the first OTP to the server for authentication. The second OTP is generated by the server based on the predefined logic. The authenticity of the first OTP and the customer identifier is checked by the server against the second OTP and a verification data. Based on the authenticity of the first OTP and the customer identifier, the server sends a payment request to the organization for completing the payment. Thus, as the customer uses a dynamic OTP for every transaction, the customer does not reveal any confidential account information at the merchant location.

The method and system described above have a number of advantages. The method is secure as the customer uses a new dynamic password for each transaction instead of his/her account details, such as a bank account number, debit card number, or a credit card account number. Further, the dynamic password is obtained by the customer using the mobile device, such as a mobile phone, a Personal Digital Assistant (PDA) and the like, which is proprietary to the customer. Therefore, the generation of the dynamic password using the mobile device involves less risk of the password being disclosed outside or being hacked over the Internet. Furthermore, the confidential account information of the customer such as account numbers, credit or debit card numbers, or equivalent identifiers that leads to the account details being derived at the server of financial institution are stored on the server of the secure payment service provider, and the secure payment service provider provides necessary information to the financial institution for completing the payment. Therefore, the method avoids sharing of the account details with E-commerce websites or merchant locations enabling buyer-seller transactions and facilitates secure online payment.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 illustrates an environment in which various embodiments of the invention may be practiced;

FIGS. 2a and 2b is a flowchart of a method for making secure payments, in accordance with an embodiment of the invention;

FIGS. 3a and 3b is a flowchart of a method for making secure payments, in accordance with another embodiment of the invention; and

FIG. 4 is a block diagram of a system for making secure payments, in accordance with an embodiment of the invention.

### DETAILED DESCRIPTION

The invention describes a method, system and computer program product for making secure payments. After selecting one or more items from an Electronic commerce (E-commerce) website or at a merchant location, a customer obtains a first One Time Password (OTP) by using his/her mobile device. The customer then enters the first OTP and a customer identifier on a secure web page or on an Electronic Data Capture (EDC) device, which may be linked with at least one of the E-commerce website, a serve of a secure payment service provider, and a website of the secure payment service provider. A system associated with the server of the secure payment service provider authenticates the first OTP and the customer identifier. Based on the authenticity of the first OTP and the customer identifier, the system sends a payment request to an organization for completing the payment.

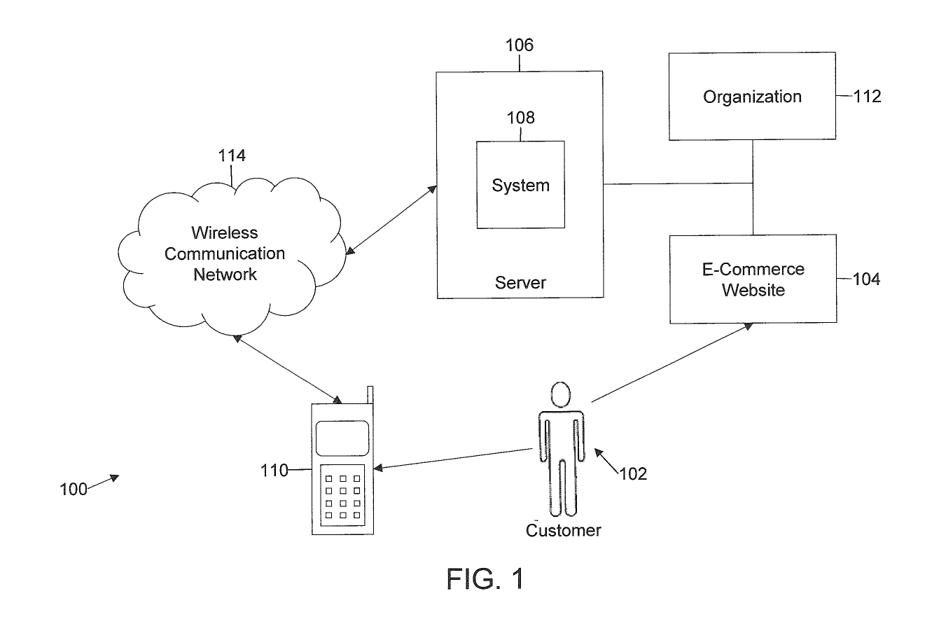

FIG. 1 illustrates an environment 100 in which various embodiments of the invention may be practiced. Environment 100 includes a customer 102, an Electronic commerce (E-commerce) website 104, a server 106, a mobile device 110, an organization 112, and a wireless communication network 114. Server 106 is associated with a secure payment service provider. Server 106 includes a system, referred to as a system 108, for making secure payments.

In an embodiment of the invention, customer 102 may be registered with the secure payment service provider for making secure payments using mobile device 110. Further, customer 102 may also be registered with organization 112 for availing one or more financial accounts. Organization 112 may be an institution which enables buyer-seller transactions such as a bank, a credit card issuing company, retail merchants, hotels, airlines, and the like. The one or more accounts may include a savings account, a salary account, a credit card account, pre-paid cards, membership accounts and the like. Mobile device 110 may be a mobile phone, a Personal Digital Assistant, and the like.

In another embodiment of the invention, the registration of customer 102 with organization 112 or secure payment service provider may be performed over the Internet, through an Automatic Teller Machine (ATM), through an Electronic Data Capture (EDC) device located at a merchant location or by physically visiting a branch of the secure payment service provider. The registration process through the ATM and EDC has been explained in detail in U.S. patent application Ser. No. 12/634,061.

In an embodiment of the invention, the information provided by customer 102 is stored as a verification data by system 108 during the registration process. In another embodiment of the invention, the information provided by customer 102 during the registration process is stored locally by mobile device 110 as a verification data. The verification data may include, but is not limited to, a customer identifier, one or more account identifiers, a copy of a Personal Identification Number (PIN), a billing address, a name of customer 102, and a date of birth of customer 102. The PIN is provided to customer 102 by organization 112 to authenticate customer 102 during various transactions. The customer identifier may include, but is not limited to, a customer defined name, a unique number defined by customer 102, and a mobile phone number of customer 102.

Customer 102 may select various items to be purchased from a list of items displayed on E-commerce website 104. Customer 102 is then connected to a secure web page for completing the transaction. The secure web page displays one or more fields where customer 102 is required to enter authentication details to complete the transaction. In an embodiment of the invention, the secure web page may be associated with E-commerce website 104 or a website of the secure payment service provider.

Customer 102 uses mobile device 110 to obtain the authentication detail to complete the payment. In an embodiment of the invention, customer 102 may download an application on mobile device 110 from server 106. Thereafter, Customer 102 installs the application on mobile device 110 for future use. Customer 102 then generates a dynamic password for every new transaction by accessing the application on mobile device 110.

In another embodiment of the invention, customer 102 may send a request to server 106 for generating the dynamic password. In response to the request, system 108 generates the dynamic password and communicates it to mobile device 110 of customer 102.

Mobile device 110 communicates with server 106 through wireless communication network 114. Wireless communication network 114 may include, but is not limited to, Global System for Mobile Communication (GSM) network, Code Division Multiple Access (CDMA) network, Wi-Fi, Wi-MAX, and the like. The communication between mobile device 110 and server 106 may be performed using a wireless communication protocol such as General Packet Radio Service (GPRS), Wireless Application Protocol (WAP), Unstructured Supplementary Service Data (USSD), Short Message Service (SMS), Multimedia Message Service (MMS), and the like.

Customer 102 then enters the dynamic password and a customer identifier as the authentication details on the secure web page to complete the transaction.

System 108 receives the authentication details entered by customer 102 from the secure web page and checks the authenticity of the entered details. Based on the authenticity of the entered details, system 108 sends a payment request to organization 112 for making the payment for the selected items.

In an embodiment of the invention, the secure payment service provider may have collaboration with E-commerce websites such as E-commerce website 104. The secure payment service provider facilitates customers such as customer 102 to make secure online transactions on E-commerce website 104. The secure payment service provider may also have collaboration with organization 112. In another embodiment of the invention, organization 112 may act as the secure payment service provider.

In another embodiment of the invention, customer 102 may make a secure payment at a merchant location (not shown). While making the payment at the merchant location, the customer generates the first OTP using his mobile device 110. The customer may then display or quote the first OTP to an employee of the merchant location. The employee may then enter the first OTP on an Electronic Data Capture (EDC) device, such as a Point-of-Sale device. The EDC device is linked with server 106 of the secure payment service provider and thus communicates the first OTP to server 106 for authentication. The second OTP is generated by server 106 based on the predefined logic. The authenticity of the first OTP and the customer identifier is checked by server 106 against the second OTP and a verification data. Based on the authenticity of the first OTP and the customer identifier, the server sends a payment request to organization 112 for completing the payment. Thus, as customer 102 uses a dynamic OTP for every transaction, the customer does not reveal any confidential account information at the merchant location.

In various embodiments of the invention, the first OTP and the second OTP may be the same. Server 106 thus authenticates the first and second OTP based on the similarity of the two passwords. In case a dissimilar first OTP is communicated to server 106, the transaction does not get completed.

In an embodiment of the invention, instead of the first OTP, customer 102 may enter a password on the secure web page or on the EDC device. The password may be generated using the application or from server 106. The password includes a unique 16 digit identifier which may serve as an identifier and authenticator. The generation of the 16 digit identifier may be based on the PIN, selected account identifier and customer identifier. The password includes customer identifier and the first OTP.

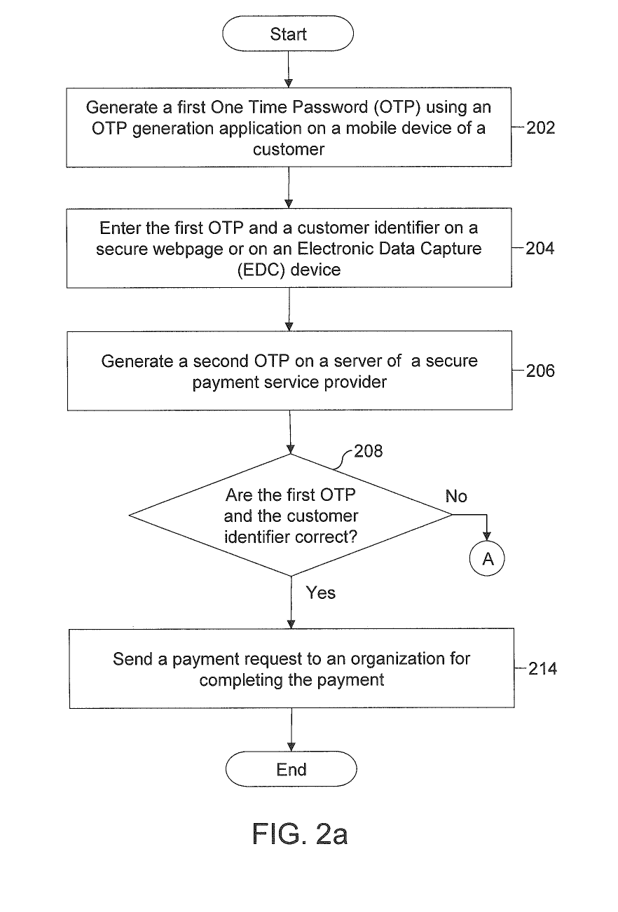

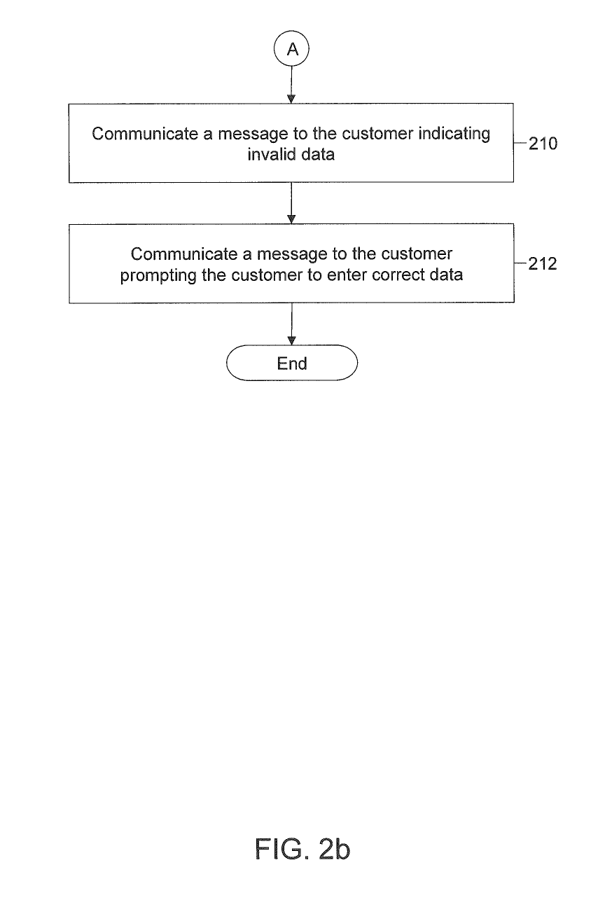

FIGS. 2a and 2b is a flowchart of a method for making secure payments, in accordance with an embodiment of the invention.

Once the registration of a customer such as customer 102 is confirmed, the customer sends a request to a server such as server 106 for downloading a One Time Password (OTP) generation application. In an embodiment of the invention the request may be sent by using a mobile device such as mobile device 110. In another embodiment of the invention the request may be sent by the customer through a website of a secure payment service provider. In yet another embodiment of the invention, the request may be sent by the customer through the EDC device, wherein a message with a link to download the application may be sent to the customer. In still another embodiment of the invention, the request may be sent by the customer through an Automated Teller Machine (ATM), wherein a message with a link to download the application may be displayed on the screen of the ATM.

The request is then received by a system such as system 108. Thereafter, the OTP generation application is sent by the system to the mobile device. The customer then installs the OTP generation application on the mobile device for future use.

The customer visits an E-commerce website, such as E-commerce website 104, or a merchant location such as a retail outlet and selects the one or more items from a list of items. In an embodiment of the invention, the customer selects an option on the E-commerce website to select the secure payment service provider for making the payment. Thereafter, the customer is connected to a secure web page. In an embodiment of the invention, the secure web page may be associated with the E-commerce website or a website of the secure payment service provider.

The customer then accesses the OTP generation application by entering a unique number such as an account-related PIN. After the successful login, one or more account identifiers are displayed on a display screen of the mobile device. An account identifier may be a bank account number, a credit card account number or a debit card account number. The customer selects an account number from which the customer wants to make the payment. Thereafter, at 202, a first OTP is generated by the OTP generation application on the mobile device. The generation of the first OTP may be based on a predefined logic implementing one or more algorithms, such as counter-based algorithms known in the art. In an embodiment of the invention, the generation of the first OTP is based on the PIN and the selected account number.

At 204, in an embodiment of the invention, the customer enters the first OTP and a customer identifier on a secure web page to complete the transaction. The first OTP and the customer identifier are then communicated by the secure web page to the system associated with the server. In another embodiment of the invention, the customer may display or quote the first OTP to an employee of the retail outlet. The employee may then enter the first OTP on the EDC device such as a point-of-sale device. The EDC device communicates the first OTP to the server for authentication. In yet another embodiment of the invention, the customer may enter a unique 16-digit password on the secure webpage or on the EDC device instead of the first OTP.

At 206, a second OTP is generated by the system for authenticating the first OTP. In an embodiment of the invention, the second OTP is generated based on the same predefined logic used for generating the first OTP.

In another embodiment of the invention, the second OTP is generated based on logic different from the predefined logic. The logic for generating the second OTP may be shared with the OTP generation application installed on the mobile device.

The generation of the second OTP may be based on a verification data corresponding to the customer. In an embodiment of the invention, the system may use a copy of the PIN and the one or more account identifiers to generate the second OTP. As explained earlier, the copy of the PIN and the one or more account identifiers are stored as part of the verification data by the system on the server at the time of the registration.

At 208, the authenticity of the first OTP and the customer identifier is checked by the system. To check the authenticity of the first OTP, the first OTP is compared with the second OTP. Similarly, to check the authenticity of the customer identifier, the customer identifier is compared with a copy of the customer identifier which is stored as part of the verification data.

If at least one of the first OTP and the customer identifier is incorrect, then, at 210, a message indicating invalid data is communicated to the customer. Thereafter, at 212, another message may be displayed to the customer for entering correct data. The message may be displayed on the secure web page. The messages are communicated to the customer by the system. In an embodiment of the invention, the messages may be communicated to the customer through the mobile device through at least one of SMS, MMS, USSD, GPRS, WAP or an automated voice call. In another embodiment of the invention, the messages may be displayed on the secure web page.

If the first OTP as well as the customer identifier is correct, then, at 214, a payment request is sent by the system to an organization, such as organization 112, for completing the payment. The system provides necessary information, such as the account number, to the organization for completing the payment. Thereafter, the organization makes the payment from the account number selected by the customer.

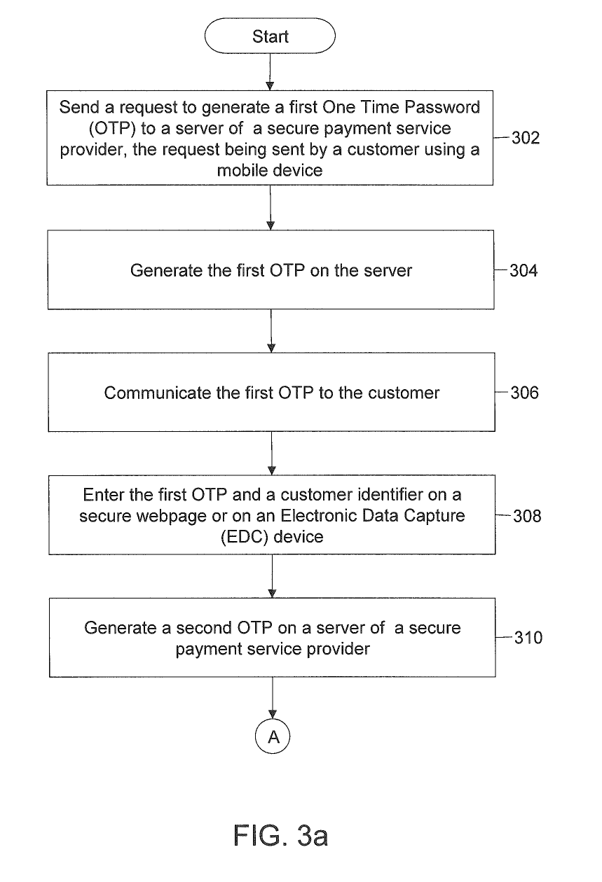

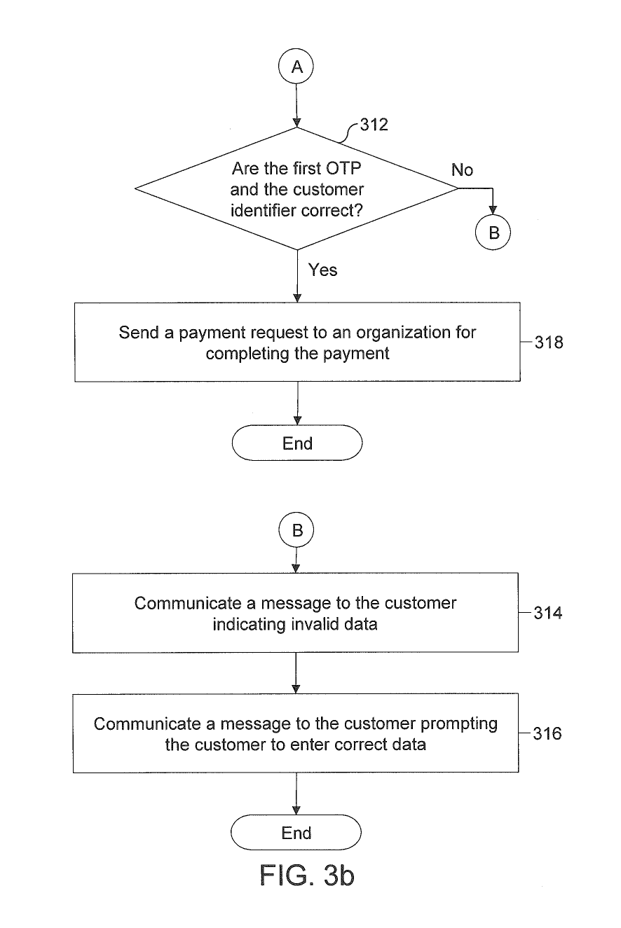

FIGS. 3a and 3b is a flowchart of a method for making secure payments, in accordance with another embodiment of the invention. The secure payment needs to be provided to a customer such as customer 102 who visits an E-commerce website, such as E-commerce website 104, and selects one or more items from a list of items, in accordance with the embodiment of the invention.

When the customer initiates the transaction, the customer may be directed to a secure web page. The secure web page may be associated with the E-commerce website or a website of the secure payment service provider.

At 302, the customer sends a request for generating a first OTP to a server, such as server 106, of the secure payment service provider. The request may include a PIN and an account number of the customer. The request is then received by a system such as system 108.

At 304, the first OTP is generated by the system. The generation of the first OTP is based on a predefined logic. In an embodiment of the invention, the predefined logic may be a counter-based algorithm and the generation of the first OTP may also be based on the PIN and the account number of the customer.

Thereafter, at 306, the first OTP is communicated to the customer by the system. In an embodiment of the invention, the customer may receive the first OTP on a mobile device such as mobile device 110. The communication between the mobile device and the system is performed through a wireless communication network, such as wireless communication network 114. The communication may be performed through SMS, MMS, USSD, GPRS, WAP, and the like.

In another embodiment of the invention, the first OTP may be displayed on the secure web page.

At 308, the customer enters the first OTP and a customer identifier on the secure web page to authenticate the payment.

At 310, the system, after receiving the first OTP and the customer identifier from the secure web page, generates a second OTP to authenticate the first OTP. In an embodiment of the invention, the second OTP is generated based on the same predefined logic as used for generating the first OTP. In another embodiment of the invention, the second OTP is generated based on logic different from the predefined logic.

At 312, the authenticity of the first OTP and the customer identifier is checked by the system. To check the authenticity, the first OTP is compared with the second OTP, and the customer identifier is compared with a copy of the customer identifier which is stored as part of the verification data.

If at least one of the first OTP and the customer identifier is incorrect, then, at 314, a message indicating invalid data may be communicated to the customer. Thereafter, at 316, another message prompting the customer to enter correct data may be communicated to the customer by the system. The messages may be communicated to the customer by the system. In an embodiment of the invention, the messages may be communicated to the mobile device through at least one of SMS, MMS, USSD, GPRS, WAP or an automated voice call. In another embodiment of the invention, the messages may be displayed on the secure web page.

If the first OTP as well as the customer identifier is correct, then, at 318, a payment request is sent by the system to an organization, such as organization 112, for completing the payment. The system provides necessary information, such as the selected account number, to the organization for completing the payment. Thereafter, the organization makes the payment from the account number selected by the customer.

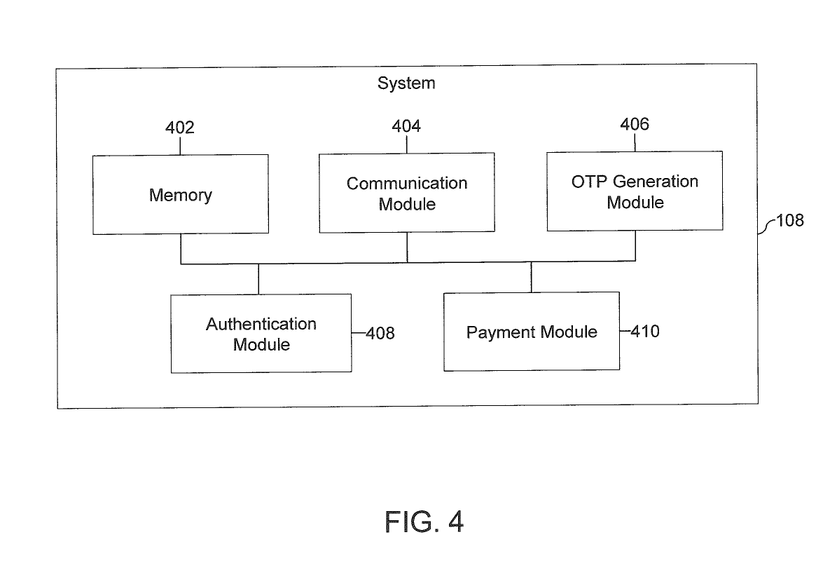

FIG. 4 is a block diagram of system 108 for making secure payments, in accordance with an embodiment of the invention. System 108 includes a memory 402 for storing the verification data corresponding to customer 102 at the time of registration, a communication module 404, an OTP generation module 406, an authentication module 408, and a payment module 410.

In an embodiment of the invention, communication module 404 receives a request for downloading an OTP generation application from customer 102. The request for downloading the OTP generation application may be sent in accordance with various embodiments of the invention described in FIG. 2. Communication module 404 then sends the request to OTP generation module 406. Thereafter, OTP generation module 406 sends the OTP generation application to mobile device 110 through communication module 404.

After downloading the OTP generation application, customer 102 installs the OTP generation application on mobile device 110. Customer 102 then generates a first OTP using the OTP generation application. Further, the first OTP may be generated in accordance with various embodiments of the invention described in FIG. 2.

In another embodiment of the invention, communication module 404 or a receiving module in system 108 receives a request for generating the first OTP from customer 102. The request for generating the first OTP may include a PIN and an account number of customer 102. Communication module 404 then sends the request to OTP generation module 406. In response to the request, OTP generation module 406 generates the first OTP. Further, the first OTP may be generated in accordance with various embodiments of the invention described in FIG. 3.

OTP generation module 406 communicates the first OTP to customer 102 through communication module 404. In an embodiment of the invention, the first OTP may be communicated to mobile device 110 through SMS, MMS, USDD or an automated voice call. In another embodiment of the invention, the first OTP may be displayed on a secure web page. The secure web page may be associated with E-commerce website 104 or a website of the secure payment service provider.

After obtaining the first OTP, customer 102 enters the first OTP and a customer identifier on the secure web page for authenticating the payment. Authentication module 408 then receives the first OTP and the customer identifier through communication module 404.

OTP generation module 406 generates a second OTP for authenticating the first OTP. In an embodiment of the invention, OTP generation module 406 generates the second OTP based on the similar predefined logic used for generating the first OTP. In another embodiment of the invention, the second OTP may be generated based on another logic which may be shared between the OTP generation application and OTP generation module 406.

In an embodiment of the invention, OTP generation module 406 may use a copy of PIN and one or more account identifiers stored as part of the verification data to generate the second OTP.

Authentication module 408 then checks the authenticity of the first OTP by comparing the first OTP with the second OTP. Similarly, authentication module 408 checks the authenticity of the entered customer identifier by comparing the customer identifier with a copy of it stored as part of the verification data.

After checking the authenticity of the first OTP and the customer identifier, if at least one of the first OTP and the customer identifier is found to be invalid, authentication module 408 may communicate a message indicating invalid data to customer 102. The message indicating the invalid data is communicated through communication module 404. Further, authentication module 408 may communicate a message prompting customer 102 to enter correct data through communication module 404. Various embodiments for communicating the messages have been explained in conjunction with FIG. 2 and FIG. 3.

If the first OTP as well as the customer identifier is correct, then payment module 410 sends a payment request to organization 112 for making the payment for the selected items. Further, payment module 410 provides information such as the account number of customer 102 and the amount to be deducted to organization 112 for completing the payment. Thereafter, organization 112 makes the payment to E-commerce website 104.

The method and system described above have a number of advantages. The method is secure as a customer uses dynamic passwords such as a first One Time Password (OTP) instead of revealing account details, such as a bank account number, debit card number, or a credit card account number, for every payment. Further, the first OTP is obtained by the customer using his or her mobile device, which is proprietary to the customer. Therefore, the generation of the first OTP using the mobile device involves less risk of the first OTP being disclosed outside or being hacked over the Internet. Furthermore, the account details of the customer are stored on a secure server of the secure payment service provider, and the secure payment service provider provides necessary information to the financial institution for completing the payment. Therefore, the method avoids sharing of the account details with multiple E-commerce websites.

The system for making secure payment over the Internet, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for making secure payment over the Internet. The computer program product includes a computer usable medium having a set program instructions comprising a program code for making secure payment over the Internet. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention, as described in the claims. The embodiments described above provide various embodiments to make proximal and non-proximal payments more secure. The foregoing description of several methods and embodiments of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

1. A method for making secure payment using a mobile device the payment corresponding to one or more items being purchased by a customer, the method comprising:
a. obtaining a first One Time Password (OTP), the first OTP being obtained using the mobile device of the customer;
b. entering the first OTP and a customer identifier on an Electronic Data Capture (EDC) device;
c. authenticating the first OTP and the customer identifier based on a second OTP and a verification data corresponding to the customer, the authentication being performed by a server of a secure payment service provider comprising the verification data, the second OTP being generated by the server; and
d. sending a payment request to an organization for completing the payment, wherein the payment request is sent by the server based on the authenticity of the first OTP and the customer identifier.

2. The method according to claim 1, wherein the first OTP is obtained by using an OTP generation application, the first OTP being generated by the OTP generation application on the mobile device, the OTP generation application being downloaded from the server.

3. The method according to claim 1, wherein the first OTP is generated by the server, the generation of the first OTP being based on a request from the customer.

4. The method according to claim 3 further comprising communicating the first OTP to the mobile device of the customer.

5. The method according to claim 4, wherein the mobile device communicates with the server using a wireless communication protocol.

6. The method according to claim 1, wherein the EDC device is linked with the server of the secure payment service provider.

7. The method according to claim 1 further comprising registering the customer with the secure payment service provider.

8. The method according to claim 7 further comprising storing the verification data on the server at the time of the registration, wherein the verification data includes at least one of the customer identifier, one or more account identifiers, a copy of a Personal Identification Number (PIN), a billing address, a name of the customer and a date of birth of the customer, the PIN being provided to the customer by the organization for authenticating the customer.

9. The method according to claim 8 further comprising selecting an account number using the one or more account identifiers, the selection of the one or more account identifiers being performed by the customer using the mobile device, wherein the payment is made from the selected account number.

10. The method according to claim 9, wherein the generation of the first OTP is based on at least one of the one or more account identifiers and the PIN.

11. The method according to claim 8, wherein the generation of the second OTP is based on the verification data.

12. The method according to claim 1, wherein the first OTP and the second OTP are generated using a predefined logic.

13. The method according to claim 12, wherein the first OTP and the second OTP are the same.

14. The method according to claim 1, wherein the customer identifier is at least one of a customer defined name, a customer defined number and a mobile device number of the customer.

15. The method according to claim 1, wherein the entering comprises a password being entered by the customer, the password being generated using at least one of the first OTP, the customer identifier and the PIN.

16. A system for making secure payment using a mobile device, the payment corresponding to one or more items being purchased by a customer, the system being associated with a server of a secure payment service provider, the system comprising:
a. a One Time Password (OTP) generation module configured for enabling the customer to generate a first OTP by using the mobile device;
b. a receiving module configured for receiving the first OTP and a customer identifier from the customer, the first OTP and the customer identifier being entered by the customer on an Electronic Data Capture (EDC) device;
c. an authentication module configured for authenticating the first OTP and the customer identifier based on a second OTP and a verification data corresponding to the customer, the verification data being stored on the server, the second OTP being generated by the OTP generation module; and
d. a payment module configured for sending a payment request to an organization based on the authenticity of the first OTP and the customer identifier, wherein the payment request is sent to the organization for completing the payment.

17. The system according to claim 16, wherein the OTP generation module is configured for sending an OTP generation application to the mobile device of the customer, the OTP generation application being sent based on a request initiated by the customer.

18. The system according to claim 17, wherein the OTP generation application generates the first OTP, the OTP generation application being accessed using the mobile device.

19. The system according to claim 16, wherein the OTP generation module generates the first OTP based on a request sent by the mobile device to generate the first OTP.

20. The system according to claim 19, wherein the OTP generation module is further configured for communicating the first OTP to the mobile device.

21. The system according to claim 20, wherein the mobile device communicates with the server using a wireless communication protocol.

22. The system according to claim 16, wherein the EDC device is linked with the server of the secure payment service provider.

23. The system according to claim 16, wherein the customer is registered with the secure payment service provider.

24. The system according to claim 23 further comprising a memory configured for storing the verification data at the time of the registration, wherein the verification data includes at least one of the customer identifier, one or more account identifiers, a copy of a Personal Identification Number (PIN), a billing address, a name of the customer and a date of birth of the customer, the PIN being provided to the customer by the organization for authenticating the customer.

25. The system according to claim 24, wherein the generation of the first OTP is based on at least one of an account number and the PIN, the account number being selected by the customer from the one or more account identifiers using the mobile device.

26. The system according to claim 24, wherein the OTP generation module generates the second OTP based on the verification data.

27. The system according to claim 16, wherein the first OTP and the second OTP are generated using a predefined logic.

28. The system according to claim 16, wherein the customer identifier is at least one of a customer defined name, a customer defined number and a mobile device number of the customer.

29. The system according to claim 16, wherein the organization is a financial institution.

30. A computer program product for use with a computer, the computer program product comprising a computer usable medium having a computer readable program code embodied therein for making secure payment using a mobile device, the payment corresponding to one or more items being purchased by a customer, the computer readable program code performing:
a. enabling the customer to generate a first One Time Password (OTP) using the mobile device;
b. receiving the first OTP and a customer identifier of the customer by a server of a secure payment service provider, the first OTP and the customer identifier being entered by the customer on an Electronic Data Capture (EDC) device;
c. authenticating the first OTP and the customer identifier based on a second OTP and a verification data corresponding to the customer, the authentication being performed by the server comprising the verification data, the second OTP being generated by the server; and
d. sending a payment request to an organization for completing the payment, wherein the payment request is sent by the server based on the authenticity of the first OTP and the customer identifier.

31. The computer program product according to claim 30, wherein the computer readable program code performs sending an OTP generation application to the mobile device of the customer, the OTP generation application being sent based on a request being initiated by the customer.

32. The computer program product according to claim 31, wherein the first OTP is generated by the OTP generation application.

33. The computer program product according to claim 30, wherein the computer readable program code performs generating the first OTP based a request to generate the first OTP, the request for generating the first OTP being sent by the mobile device to the server.

34. The computer program product according to claim 33, wherein the computer readable program code further performs communicating the first OTP to the mobile device of the customer.

35. The computer program product according to claim 34, wherein the mobile device communicates with the server using a wireless communication protocol.

36. The computer program product according to claim 30, wherein the customer is registered with the secure payment service provider.

37. The computer program product according to claim 36, wherein the computer readable program code further performs storing the verification data on the server at the time of the registration, wherein the verification data includes at least one of the customer identifier, one or more account identifiers, a copy of a Personal Identification Number (PIN), billing address, the name and a date of birth of the customer, the PIN being provided to the customer by the organization for authenticating the customer.

38. The computer program product according to claim 37, wherein the generation of the first OTP is based on at least one of an account number and the PIN, the account number being selected by the customer from the one or more account identifiers using the mobile device.

39. The computer program product according to claim 37, wherein the computer readable program code further performs generating the second OTP based on the verification data.

40. The computer program product according to claim 30, wherein the first OTP and the second OTP are generated using a predefined logic.
